(19) United States
(12) Patent Application Publication
(10) Pub. No.: US 2011/0125702 A1
(43) Pub. Date: May 26, 2011

(54) DECISION SUPPORT METHODS UNDER UNCERTAINTY

(76) Inventors: Prasanna Gorur Narayana Srinivasa, Bangalore (IN); Abhilasha Aswal, Bangalore (IN); Manjunath Appasaheb Sindagi, Bangalore (IN); Ravi Kumar Jain, Bangalore (IN); Jyotsna Chatradhi, Bangalore (IN); Khyati Sanghvi, Bangalore (IN); Reshma Ratnani, Bangalore (IN)

(21) Appl. No.: 13/003,192

(22) PCT Filed: Jul. 9, 2009
(86) PCT No.: PCT/IN09/00390

§ 371 Date: Jan. 31, 2011

(30) Foreign Application Priority Data
Jul. 10, 2008 (IN) 1677/CHE/2008

(51) Int. Cl. G06N 5/02

(52) U.S. Cl. 706/52

(57) ABSTRACT

Modern decision support methods handle uncertainty or hypothesis about operating conditions, using one of two techniques viz. probabilistic formulation and constraints based method, which is the subject of the present invention. A large number of applications use linear constraints to specify uncertainty. These linear constraints are the set of linear inequalities, which are used to define the demand/supply in the area of supply chains. The set of linear inequalities forms a polytope, the volume of which represents the information content. The present invention deals with the application of computational geometrical methods to find the set theoretic relationship—subset, intersection and disjointness among the polytopes and then present a visualization technique to represent these relationships among polytopes. This invention proposes a decision support system and method to visualize the relationship among the polytopes to help with decision support. A specific embodiment is a Decision Support System for Supply Chain Management.

### FIELD OF THE INVENTION

This invention proposes a decision support system and method to visualize the relationship among the polytopes in order to help with decision support. In specific, the visualization system includes a relational algebra visualize used to provide various methodical points of assistance to users making decisions.

### DISCUSSION OF PRIOR ART

US2002107819A proposes a Strategic Planning and Optimization System that uses historical sales data to predict optimal prices and similar factors for meeting a number of business goals. Unlike previous systems that allow a user to model prices and other factors based on physical constraints, the present invention allows the optimization to occur against the background of one or more strategic objectives. Such objectives, such a price image, are not set by physical constraints but instead are imposed by the user with the notion that they will provide a strategic and ultimately an economic advantage. The system allows the analysis of the costs and benefits of such management imposed strategic objectives.

Two major techniques for handling uncertainty in algorithms are Stochastic Programming [BGN*04] [SAG*03] and Robust Programming [BT06] [BN98]. The word “uncertainty” is taken to mean insufficient knowledge—all parameters cannot be specified completely. Stochastic Programming uses a probabilistic formulation of the world and single/dual stage optimization (with recourse) can be used to optimize expected values of the size, capacity, cost etc. The probability distribution that is assumed affects the outcome of the result and the distribution is difficult to estimate in practice. Robust programming assumes a set of scenarios (a scenario is a set of values for all the parameters), and optimizes the worst-case value of the metric over the set of scenarios. The limitation of Robust Programming is the generation of set of scenarios. Prior work in this field has extended and applied the robust programming formulations in the context of supply chains, credit risk, and finance and so on. This prior work mitigates the scenario specification difficulty, by specifying sets of scenarios as a hierarchical set of ensembles, each ensemble being specified by linear or in general convex constraints, these constraints having domain specific meaning. These ensembles provide a framework for decision support—determination of relationships between ensembles provides a framework for analyzing the relationships between different sets of assumptions about uncertainty. The proposed invention finds the relationships between these ensembles (that drive the robust optimization) and also, presents a visualization technique, which is useful in decision support.

Robust programming in the simplest form adds uncertainty to an optimization problem specified as a linear program (this formulation encompasses many optimizations, including path optimizations, flow optimizations, topological optimizations, etc):

MinC^{t}X

Ax<=b

The uncertainty can be in the elements of matrix A, right hand side b, or cost coefficients C. These uncertainties represent limited knowledge about system parameters (e.g. future demand), and the optimization has to be the best taking all these possibilities into account. It is easy to show that all these uncertainties can be represented by constraints on A only, keeping C and b fixed [BT06]. Different assumptions about the uncertainties on the matrix elements Aᵢⱼ lead to different classes of problems, ranging from linear programming itself to quadratic/Second Order Cone Programming (SOCP)/Semi-Definite Programming (SDP) formulations (in cases of quadratic constraints) [BT06].

In a large class of applications, the constraints on the matrix elements, cost coefficients, right hand sides, etc. are linear (or quadratic) constraints. For example, in supply chains, the R.H.S b represents demands, which have to be often forecasted. Aggregates of these demands, differences between related demands/sets of demands etc can be forecasted better than each individual element, leading to linear constraints [PA03]. In such cases, the robust programming problem is to optimize the metric under linear (or quadratic) constraints on the matrix elements). In general this results in upper/lower bounds on the metric as the parameters vary satisfying the constraints. These bounds can be determined using techniques of convex optimization developed in the last decade by [BT06] [BN98] [BN99] [BN00].

Clearly, the bounds produced by robust optimization techniques are valid for only the particular constraint set assumed—the specific ensemble of scenarios is illustrated in FIG. 1 of the accompanying drawings (better and more illustrative diagram, with multiple polytopes and associated bounds—maybe show the contour lines of C^{T}x, also show a simple example right here with 2 goods). Different ensembles (sets of constraints) will result in general in different answers. Comparison amongst different answers requires both qualitative and quantitative comparison amongst the ensembles, which is handled using polytope geometric algorithms. Qualitative comparisons are set-theoretic—subset, intersections and disjointness, reflecting more specific assumptions, overlapping assumptions, and totally separate assumptions about the future respectively. Quantitative comparisons are handled using information theoretic concepts.

### SUMMARY OF THE INVENTION

The present invention has several advantages, including the ability to handle ensembles composed of an infinite number of scenarios, representing an infinite set of assumptions about the future. Additionally, the use of polytope (in general convex body) geometric algorithms enables one to compare different sets of assumptions both qualitatively (using subset, intersection, and disjointness relations between two polytopes) and quantitatively (polytope volume) facilitating decision support. The main challenge is dimensionality of the polytopes (or in general convex bodies)—large problems can have millions of dimensions, challenging the fastest polytope geometry algorithms known to date. This invention illustrates the applicability of existing computational geometry algorithms, for the comparison and visualization of different polytopes corresponding to different sets of future assumptions, for medium scale problems with 1000's of variables. Described herein are key elements of a software package based on the above, for decision analysis and optimization. These techniques will become more useful as more powerful computational geometry algorithms are developed.

Visualization of sets of N-dimensional Convex Polytopes is extremely challenging. In classical set theory, the relation between polytopes treated as sets (subset, disjointness, intersection) is shown using Venn diagrams. This cannot be meaningfully applied for representing the relationship among high-dimensional polytopes, due to complex relationships encountered between polytopes, and associated clutter in the Venn Diagram. There is a parallel coordinate technique [ID90] [C195], which represents an N-dimensional object in 2-dimensional space, but this is not intuitive to the decision maker, and looses information. Moreover, the problem that has been dealt here has polytopes specified by linear constraints, the vertices of which are unknown. Computing the vertices [AD00] is itself an exponential process, and does not scale to thousands to millions of dimensions. There is a visualization scheme that is presented in [CI01] to find the solution of a 3-D linear programming problem, but that is meant to understand the solution process and not the relations among polytopes. Work at Cornell University [CU] on supply chains, deals with non-linear relationships among thousands of parts at hundreds of location using animations and not with the representation of relationships among convex polytopes representing uncertainty. The contribution herein, is applying relational algebraic concepts to find relations between polytopes and also a visualization technique for these relations. This contribution enables different sets of assumptions about the future to be compared in a global manner, without comparing only sample points belonging to different sets (local comparison). As such it offers a powerful tool for decision analysis and optimization under uncertainty, a topic of current interest.

### BRIEF DESCRIPTION OF DRAWINGS

FIG. 1 illustrates a Convex Polytope in which each of the point inside the polytope forms a scenario;

FIG. 2 illustrates a subset;

FIG. 3 illustrates an intersection;

FIG. 4 illustrates disjoint sets;

FIG. 5 illustrates the volume of information content;

FIG. 6 illustrates the supply chain;

FIG. 7 illustrates a graphical visualization for algorithm for subset;

FIG. 8 illustrates a graphical visualization for algorithm for intersection;

FIG. 9 illustrates the runtime for intersection relation between constraint sets;

FIG. 10 illustrates the runtime for subset relations between sets;

FIG. 11 illustrates runtime for K-way intersection relations between sets;

FIG. 12 illustrates the input analysis phase; and

FIG. 13 illustrates the Time Series of Relations, together with inter-polytope max distances.

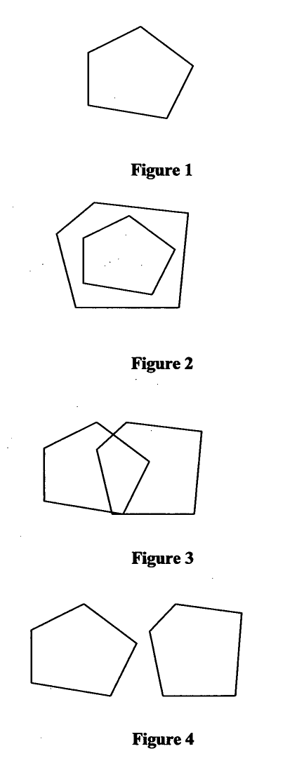

### DETAILED DESCRIPTION OF PREFERRED EMBODIMENTS

### Qualitative and Quantitative Set Comparisons

Qualitative Set theoretic Relationships:

Qualitative set theoretic relationship between polytopes is illustrated below. FIGS. 2, 3 and 4 show polytopes in 2-Dimensions, usually the constraint sets specified for large applications consists of tens of thousands or even million variables forming an N-dimensional polytope. While the present work is specified in terms of linear constraints and associated polytopes, the results are valid for general convex constraints and associated N-dimensional convex bodies, provided more sophisticated algorithms based on convex optimization (REF) are used.

Subset: This is the case when one of the polytope forms a subset of other (FIG. 2)—the larger polytope includes all the possibilities about the future corresponding to the smaller, and may have some more also. In this case, the volume of information content (explained in section 3.2) in the larger polytope is more than the smaller one, which implies that larger polytope is more uncertain. By adding more constraints to the larger polytope, more information is added and hence uncertainty decreases.

Intersection: In this case, the polytopes intersect each other (FIG. 3)—there are some commonalities that exist between the assumptions about the future represented by the polytopes. These commonalities refer to those sets of parameters that satisfy both the constraint sets.

Disjoint: The polytopes do not intersect; they are disjoint sets (FIG. 4). In other word s, there is no commonality amongst assumptions represented by these polytopes.

### Quantitative Information Estimates:

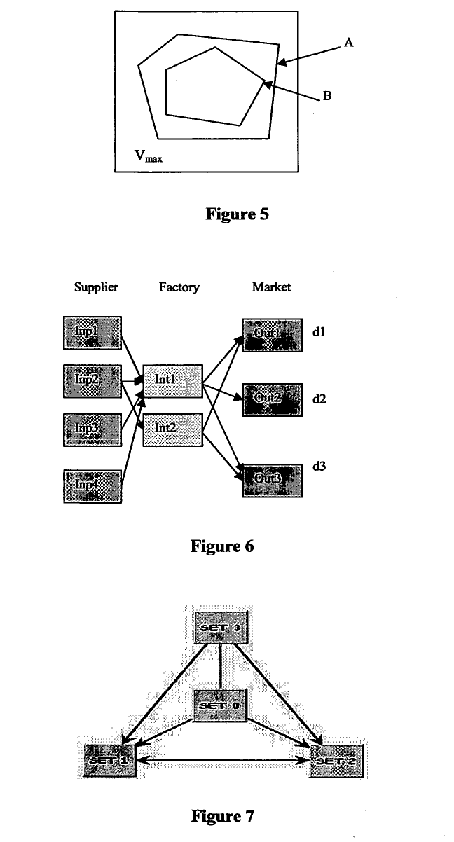

FIG. 5 shows two scenario ensembles,—A and B, B being a subset of A. Bounds on the metric of interest as the parameters varying inside B clearly are tighter than the bounds that vary inside the larger polytope A. The amount of information represented by the polytopes A and B, can be quantified as follows. Assume that in the lack of information, all scenarios in large region R are equally probable. R is taken to be of finite volume (for simplicity initially) Vₘₐₓ. Then the constraints specifying any convex polytope CP (e.g. A) specify a subset of Region R, of Volume V_{CP}. The amount of information provided by the constraints specifying the convex polytope can be equated to the Shannon [Sha48] surprisal of scenarios falling within CP given by

$$I = log 2 ( \frac{{V}_{max}}{{V}_{Cp}} ) bits \qquad ( 1 )$$

Relative comparison of the information content among different polytopes (Say for A and B in FIG. 5) can be done by comparing their relative volume as follows

$${I}_{1} - {I}_{2} = log 2 ( \frac{{V}_{CP 2}}{{V}_{CP 1}} ) \qquad ( 2 )$$

An algorithm to compute the volume of convex bodies is given in [LV03]. This algorithm is of the Order O(n⁴), which does not scale to the problem addressed herein, since problems with 1000's of dimensions are commonplace. However, most meaningful and easily interpreted ensembles are composed of simple linear constraints, with sums of parameters, differences, etc, and special techniques for such structured polytopes can be used to scale to the large number of dimensions encountered in this application. Due to the large number of dimensions, it is also evident that the volume cannot be represented using a reasonable number of digits; rather its logarithm is used.

### An Example—Supply Chain Management

The concepts explained above are applied by taking Supply chain as an example. A typical supply chain consisting of supplier, factory and market is as shown in FIG. 6. It may consist of other intermediate nodes like warehouse, dealers etc. A supply chain necessarily involves decision about future operations like demands, supplies etc. However, forecasting for large number of commodities is difficult, especially for new products. Techniques of robust optimization are applied, by specifying the ensembles using linear constraints (which are the aggregates or the differences) on demand variables, supply variables, production variables, warehouse capacity variables etc. The number of linear constraints is typically smaller than the number of variables. By specifying the linear constraints on demand, it is possible to find the optimum supplies needed through the techniques of robust optimization [BT06] [BN98] [BN99] [BN00]. As shown in FIG. 6, d1, d2 and d3 are the demands that are uncertain. For ease of explanation, Let us consider only demands d1 and d2. For specificity, assume that d1 is one brand of soap and d2 is its competitor. Now, these demands can be expressed in the form of linear constraints as follows

1. Limits per demand, e.g. for demand 1

Min 1<=d1<=Max1.
This specifies only a priori knowledge about the limits on demand 1 (for toothpaste and/or its competitor).

2. Substitutive demands

Min2<=d1+d2<=Max2
As the demand for soap one increases, the demand for the other has to decrease so as to maintain the constraints with the specified limits, reflecting total industry size constraints.

3. Complementary demands

Min3<=d1−d2<=Max3
As the demand for one brand of soap increases, the demand for other brand also has to increase for the difference to be within the specified limits such a constraint reflects a competitive response of the second brand to the first brands increase.

These linear constraints form a polytope. There may be several different polytopes corresponding to different constraint sets. For example, consider the following three constraint sets:

### Case 1: Constraint Set—CP1

200<=d1+d2<=400

0<=d1−d2<=200

0<=d2−d1<=200

### Case 2: Constraint Set—CP2

250<=d1+d2<=350

0<=d1−d2<=100

0<=d2−d1<=100

### Case 3: Constraint Set—CP3

250<=d1+d2<=350

0<=d1−d2<=100

0<=d2−d1<=300

Now, it is evident that CP2 is a subset of CP1 and also CP2 is subset of CP3, where as CP3 intersects with CP1. The notion of subset says that one is more specific than the other, implying one is less uncertain than the other and the intersection says that there are a set of commonalities among the two sets. Now, these set theoretic relationships among these polytopes are found by applying methods described in section 5 and represented graphically as mentioned in section 6. This two dimensional example can be solved by most LP solvers, but in large applications like supply chains, millions of variables exist, necessitating solvers like CPLEX.

Quantification of the relative information content between the sets CP1 and CP2, CP2 and CP3, and between CP3 and CP1 is done using algorithms for polytope volume (Equation 2) and the results are given below (volume here is the area of the polytope in 2 dimensions).
Volume of CP1−V_{CP1}=38500 square units.
Volume of CP2−V_{CP2}=10125 square units.
Volume of CP3−V_{CP3}=20625 square units.
Information in CP2 relative to CP1:

I₁−I₁=log₂V_{CP1}/V_{CP2}=1.92 bits
Information in CP2 relative to CP3:

I₂−I₃=log₂V_{CP3}/V_{CP2}=1.02 bits
Information in CP1 relative to CP3:

I₃−I₁=log₂V_{CP1}/V_{CP3}=0.9 bits

This quantifies the relative uncertainty in different polytopes.

### Qualitative Decision Support—Relational Algebra of Convex Polytopes

A set theoretic relational algebra for polytopes (which generalizes to convex bodies) can be developed as follows. This relational algebra can be used in a query language for decision support as shown below.

Query Language: Let A1, A2, A3 . . . denote polytopes (or convex bodies) corresponding to different sets of assumptions about the future. A query can be written in sum-of-products form as

Q=ΣΠAᵢ₁Aᵢ₂Aᵢ₃ . . .

Where the product operation is intersection of polytopes and the sum the union (this results in non-convex bodies, and has to be handled carefully by enumeration for small number of terms). The subset and disjointness operations can also be specified using intersection as shown below in Algorithm No. 1. For example, the query—Is there at least one future possibility in Ensemble A, or is there one in the intersection of B and C and D is answered by the satisfiability of Q

Q=A+BCD

Decision support involves answering the satisfiability of Q for at least one point in the polytopes, corresponding to one possible realization of the future as per the assumptions outlined by Q.

Executing this query requires fast techniques for fundamental set-theoretic operations of polytopes—pair wise intersection, subset, and disjoint ness, and their generalizations to multiple polytopes, which is shown as follows (Pair wise). Note that all three operations are reduced to finding the intersection below:

First, suppose P and Q(P^{c and} Q^{c} are the complement of the sets P and Q) are two sets then
1 If P∩Q=φ, then P and Q are disjoint
2 If P∩Q^{c}=φ and Q∩P^{c}≠φ then P is a proper subset of Q
3 If QΩP^{c}=φ and P∩Q^{c}≠φ then Q is a proper subset of P

Based on the above Algorithm No. 1 results,

### Algorithm No. 1: Subset, Intersection and Disjointness Among Convex Polytopes

1. Take two constraint sets¹ at a time (say P and Q).²
2. Combine the linear inequalities from both P and Q to form a new set R. Check for feasibility using an LP Solver³ ¹The terms Constraint sets and Convex Polytopes are used interchangeably²Each constraint set consists of linear inequalities and both the constraint sets are not the same, if it is same then it can be checked before the executing the algorithm.³QSOPT, and the industry standard CPLEX were both used in the present work.
3. If R is Infeasible then P and Q are disjoint sets, stop. Else, Continue.
4. Take each inequality from set P, reverse the inequality sign and add it to set Q, to form a set Q′.
5. Check for the feasibility of set Q′ at step 4.
6. If Q′ is infeasible for every inequality added from P to Q with inequality sign reversed then Q is subset of P.
7. If Q′ is feasible for at least one inequality added from P to Q, then Take each inequality from set Q, reverse the inequality sign and add it to set P, to form a set P′.
8. Check for the feasibility of set P′ at step 7.
9. If P′ is infeasible for every inequality added from Q to P with inequality sign reversed, then P is subset of Q
10. Again, if feasibility exists for at least one inequality, then P and Q intersect each other.

The proof of Algorithm No. 1 is simple and omitted for brevity. The Order of the algorithm is O(m+n) calls to a linear programming (LP) Solver, with m and n being the number of linear inequalities in the two constraint sets P and Q respectively. If there are p constraint sets, then the Order of the algorithm will be O((m+n)p²) to check the relationship between all pairs. The algorithm can of course be speeded up by using special structure in the constraints, etc.

In passing, it may be noted that the large number of computational geometry algorithms that find the intersection of polytopes predominantly use vertices and/or points to compute the intersection [MP78], (which can also be used to find the subset). However, the number of vertices is exponential in the number of constraints, which makes these methods inapplicable in the present application domain. One is unaware of similar work connecting the fields of computational geometry and decision support, at least in these applications.

### Algorithm No. 2: Multi-way Disjointness, Intersection, and Subset

Algorithm No. 1 yields a yes-no answer, but does not yield a representation of the intersection of two polytopes (if non-null). This representation is required for a cascaded query (A∩B∩C). Algorithm No. 3 explicitly constructs this representation, allowing a multiple way intersection to be determined. The algorithm basically determines which of the constraints defines the intersection, and which do not.

### Algorithm No. 3: (Intersection Representation) Finding the Minimum Number of Linear Equations Forming the Intersection

1. Take two constraint sets at a time (say P and Q). *
2. Take each inequality from set P, reverse the inequality sign and add it to set Q to form set Q′.
3. Check for the feasibility of set Q′ at step 2.
4. If set Q′ is feasible, store the inequality (This inequality is forming intersection with the other polytope that is added from P to Q).
5. Repeat steps 2-4 by adding each inequality from set Q to set P, which forms set P′.
   * Each constraint set consists of linear inequalities and both the constraint sets are not same.

The algorithm is of the Order O(m+n) call to the LP Solver where m and n is the number of constraints in P and Q respectively. The estimation of polytope volume to yield quantitative information content estimates is the topic of forth coming publications—sampling methods through domain specific methods can be used.

### Graphical Visualization of Relations

Once the relationships between all pairs of polytopes is determined, using the algorithm No. 1, these relationships among the constraint sets are graphically represented using the following conventions (see FIG. 7).
1. Each constraint set is represented as a square box. They are arranged in a circular layout.
2. A directed arrow is used to represent that one constraint set is the subset of the other. For example, as shown in FIG. 7 constraint set 3 is subset of constraint set 2.
3. A double directed arrow is used to represent that one constraint set is intersecting with the other. For example, constraint set 1 intersects constraint set 2 in FIG. 7
4. If the constraint sets are equal then a straight line from one set to another is used to represent the relation of equality. Constraint set 3 and constraint set 0 are equal as shown in FIG. 7.
5. Disjoint constraint sets are not connected by any lines.

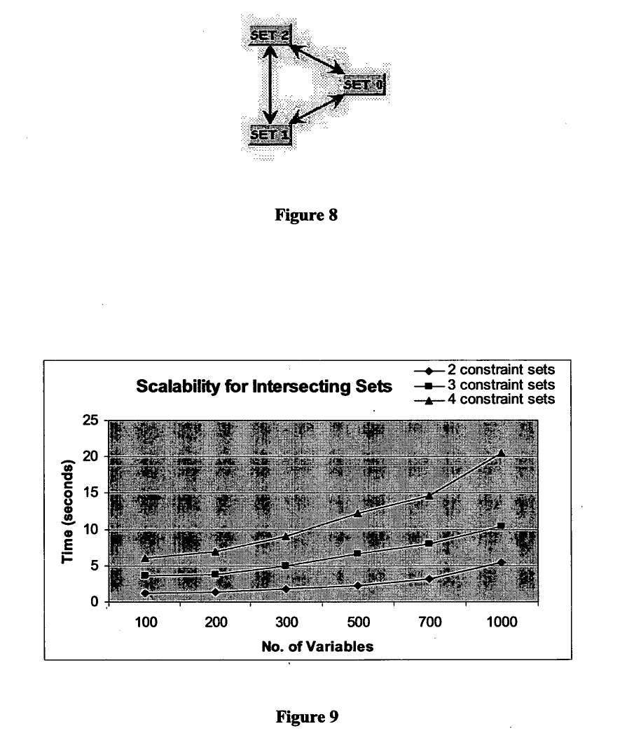

The graph obtained from algorithm No. 1 might be non-planar (usually for more than 5 constraint sets), but this is inevitable when representing topological properties of high-dimensional spaces in spaces of lower dimension. Multi-way intersection results in cliques of double arrows—this is shown in FIG. 8 for a 3-way intersection. Determination of multiway intersections is done under user control, since the number of possible combinations is exponential in the number of sets of constraints N and the order of intersection M—the number of combinations of M constraint sets out of N total constraint sets.

### Experimental Results:

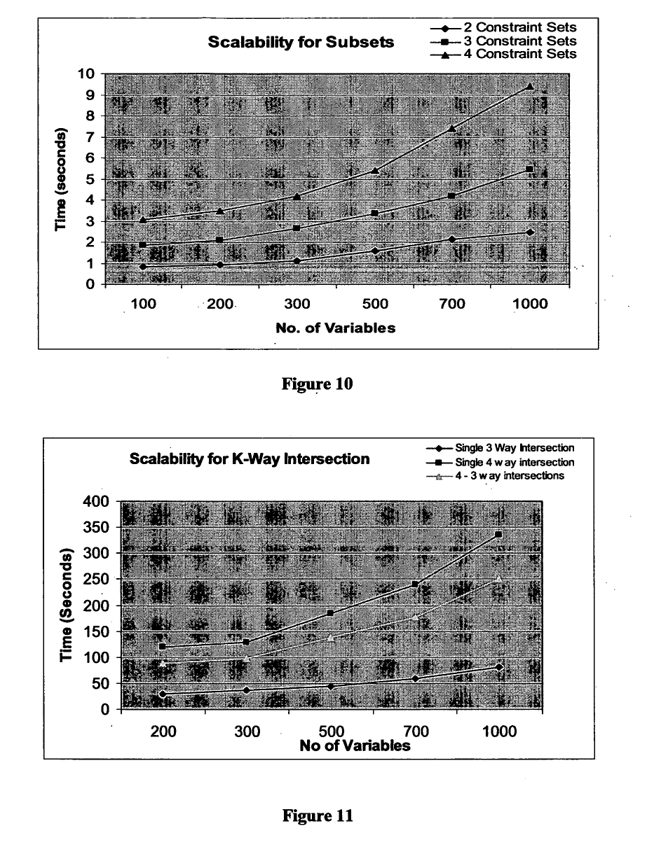

A Java implementation of algorithm No. 1 was developed, and tested using polytopes resulting from a supply chain optimization. Linear constraint sets (considering demand as variables) are generated randomly by varying the number of variables and number of constraints. The algorithm was profiled on IBM Machine with Intel 1.4 GHz, 512 MB RAM, and a disk speed of 4200 rpm. The readings have been taken by varying the number of—constraint sets, variables and inequalities. FIG. 9 and FIG. 10 shows the runtime considering two, three and four constraint sets (ensembles). Note that four ensembles correspond to four sets of assumptions about the future, each of which involves thousands to millions of variables, and many tens of constraints amongst them. FIG. 9 shows the time to determine all pair-wise intersections between the polytopes, if present, FIG. 10, likewise determines which ensemble is a subset of another, if such a relation exists. It can be seen that the time taken by the algorithm for four intersecting sets with 1000 variables and 62 constraints each is around 20 seconds and the time taken for 4 sets which are subset of each other is around 9.3 seconds (with 1000 variables in each set and 62,52,42,32 constraints in four sets respectively). Other metrics can be evaluated from the figures and Table 1. FIG. 11 shows runtime for the algorithm No. 2, it can be seen that for a single 4 way intersection the time taken for 1000 variables is around 5.5 minutes and for a single 3 way intersection the time taken is around 80 seconds. Larger problems with millions of variables can potentially be handled using high speed large-scale multiprocessors.

TABLE 1
Time Taken for Different sets.

| | | | Standard | Deviation |
|---|---|---|---|---|
| Re- | | Mean Time for | Deviation | from |
| sult | | Algorithm | from Mean | mean as |
| No | Forms | (seconds) | (seconds) | % age |
| 1 | Two | 1.145 (1.57) | 0.097 (0.166) | 8.5% (10.6%) |
| | Intersecting | | | |
| | sets^{1a} | | | |
| 2 | Two Subset | 0.854 (1.28) | 0.153 (1.155) | 17.92% (18.2%) |
| | sets^{2a} | | | |
| 3 | Four | 20.47 (21.98) | 0.88 (1.14) | 4.56% (5.61%) |
| | Intersecting | | | |
| | Sets^{1b} | | | |
| 4 | Four Subset | 9.38 (9.7) | 1.38 (1.388) | 14.17% (14.24%) |
| | sets^{3##} | | | |

Figures in bracket indicate the overall time or % age for the algorithm including Visualization
¹62 in each set
²62 and 52 in each set
³62, 52, 42, 32 in each set
^{a}No. of Variables - 100
^{b}No. of variables - 1000

### Embodiment in a Supply Chain Network Analytics Package

Based on the above description, an embodiment in a supply chain network analytics package, possibly operating in real time, is described herein. We shall refer to this as the SCMA package. A critical problem in the practice of supply chain analysis/optimization is that different assumptions result in different answers, and one is at a loss how to compare them together. SCMA enables us to thoroughly analyze this dilemma, both at the assumption (input) stage, and at the output stage.

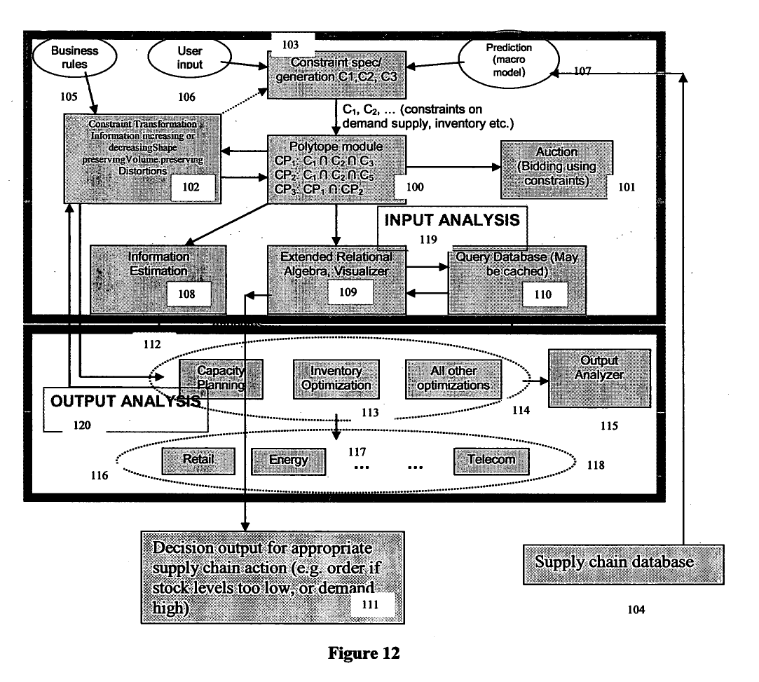

The basic operation of SCMA is as follows. (Refer FIG. 12).

First, a set of constraints is created, based on either
User Input 106, creating constraints in constraint specification/generation module 103.
Prediction 107 from historical time series data, plus a-priori information about the constraints. In other language, the input analysis engine 119 looks at the database 104 and creates an model of its contents—these are the constraints derived from the point data. In this embodiment, the invention is a database-modeling engine, which transforms point data into constraints.
Transformation 102 from me-existing constraints, preserving information content (or increasing/decreasing it).

Each set of constraints in polytope module 100 (forming a polytope if all constraints are linear) is an assumption about the supply chains operating conditions, exemplarily in the future. Multiple sets of constraints can be created (CP1, CP2, CP3, in polytope module 100), referring to different assumptions about the future.

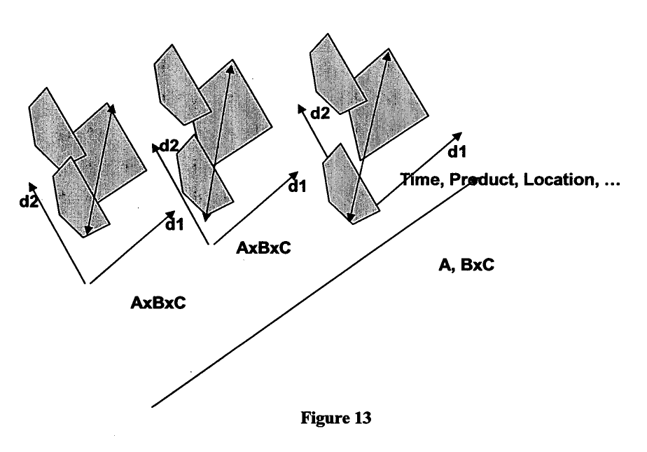

Then, SCMA's analysis, done in the input analyzer 119 is performed using the following steps (not necessarily in this order)—
1. Analysis of each assumption (polytope) by itself for information content—this is the information estimator 108 as described in our earlier PCT application published under No. WO/2007/007351.
2. Analysis of different assumptions (polytopes) in extended relational algebra module 109 to determine if
   Are two assumptions totally different—disjoint sets?
   Do they have something in common—intersecting?
   Is one a superset of the other, which is more general?
This is done in SCMA, which shows a graphical representation of answers to these questions (as in FIGS. 7 and 8) for a variety of polytopes representing different assumptions about the supply chain's operation.
3. Analysis of Sequences of constraints:
   In the case of constraints sets (polytopes) evolving with time, or other index variables, SCMA's extended relational algebra module 109, plots the evolution of the relations between the polytopes. While this can be solved by repeatedly calling the basic algorithms outlined above, these can be considerably speeded up by using methods of incremental linear programming, wherein small changes in constraints sets do not necessarily change the basis globally.
   FIG. 13 indicates three polytopes evolving with time and the relations change as a, b, c are intersecting in the first two time steps, but a is disjoint and b and c are intersecting in the third step (the convention of FIGS. 7 and 8 is not used for clarity, and the relationships are stated in textual form in FIG. 13). The distance min/max/between analytic, centers is depicted by lines between a, b, and c, and continuously shown increasing and can be determined by methods of convex optimization as described earlier. The sequence depicted need not be with respect to time, but can be with respect to product id, node id, etc.
4. Metric-based Analysis: In addition to set theoretic properties, metric-based properties (distance, volume) can also be evaluated, to obtain further information. We refer to this facility as the extended relational algebra engine.
   a. In the case of polytopes A and B, it is of interest to determine how far apart they are. This can be solved by the linear program given below. C_{A}/B_{A} is the constraint set/right hand side for A, C_{B}/B_{B} for B, and X is a point in A and Y in B.

A={X:C_{A}X<=B_{A}}

B={Y:C_{B}Y<=B_{B}}

Min∥X−Y∥

C_{A}X<=B_{A}

C_{B}Y<=B_{B}
Maximizing instead of minimizing finds the points in the two polytopes farthest from each other, and this can be used to normalize the minimum distance. Instead of the min of absolute value another norm like the L₂ norm can be used also, using convex optimization. Note that this can be used even if the polytopes are intersecting (min is always zero, and max can be determined)
In addition to the min/max distance between polytopes, the distances between two random points inside each, distance between analytic centers (using convex optimization), distances between each polytope and any or all the constraints of the other, etc can all be found using techniques well-known in the state-of-art (having runtimes polynomial in the problem size).
b. In the case of A being a subset of B, we need to know how smaller (relatively) A is compared to B. This can be estimated from volume estimation methods, comparing the volume of A to B by sampling algorithms
c. In the case of A and B being neither disjoint nor subsets, we would like to know what percentage of A and B are in the intersection, which can be analyzed using volume estimation methods, using either A or B as a normalizing volume.

In addition to the distances and volumes, projections of the polytope along the axes or random directions can be used to determine their geometric relations.

The relational algebra relations (subset, disjoint, intersecting), together with associated min/max distances between polytopes, and their volume, form the basis for input analysis. FIG. 13 also has the distances marked.

In a real time supply chain, inputs are read from the SCM database 104 in FIG. 12, which is updated in real time. The answers from input analysis can be used to trigger responses 111 in FIG. 12, where exemplarily orders are triggered if stock levels are too low, or demand levels are high.

### SCMA Database

SCMA operates on sets of constraints derived from exemplarily historical data in a database 104 in FIG. 12. The constraints are arbitrary linear or convex constraints, in demand, supply, inventory, or other variables, each variable exemplarily corresponding to a product, a node and a time instant. The number of variables in the different constraints (constraint dimensionality) need not be the same. Zero dimensional constraints (points) specify all parameters exactly. One-dimensional constraints restrict the parameters to lie on a straight line, 2-D ones on a plane, etc.

These constraint sets are the atomic constituents of an ensemble of polytopes, which are made using combinations of them, as shown in the examples below:
P1=C1 AND C2
P2=C1 AND C3
P3=P1 AND P2

Note that the third polytope is succinctly written as the intersection of P1 and P2. The set of all the polytopes (of various dimensions), together with the constraints forms a database of constraints, part of which is attached to polytope module 100 (but not shown to avoid cluttering the diagram), and part of which is in query database 110. This database of constraints drives the complete decision support system. These constraints and polytopes can be time dependent also. The constraint database is stored in a compressed form, by using one or more of:
1. Standard Compression Techniques like Lempel-Ziv.
2. Optimizing Polytope Representation in terms of other polytopes, i.e. using the most succinct representation, determined using algebraic simplification.

Then these polytopes are analyzed to determine their qualitative and quantitative relations with each other, as outlined in the description above.

### Database Optimizations.

In addition to one-shot analyses of relationship between polytopes, decision support systems have to support repeated analyses of different relations made up of the same constraint sets. Let A, B, C, D, and X be constraint sets (polytopes). Then in a decision support system, we would like to verify the truth of

A≠φ

B≠φ

C≠φ

A⊂B

A⊂C

B⊂C

X=B×C

D=A×X∪B

B×(A×X)=φ

A×(B×C)−D=B

One method is to explicitly compute these expressions ab-initio from the relational algebra methods presented in the thesis. However, the existence of common subexpressions between the X=B×C, and A×(B×C)−D enables us to pre-compute the relation X=B×C (this is an intersection of two constraint sets, which can be obtained by methods like those described in Algorithm 5.3), and use it directly in the relation A×(B×C)−D. Common sub-expression elimination methods (well known in compiler technology) can be used to profitably identify good common subexpressions. These methods require the costs of the atomic operations to determine a good breakup of a large expression into smaller expression, and these costs are the costs of atomic polytope operations (disjoint, subset, and intersection) as outlined in the description above. These costs depend of course on the sizes of the constraint sets—the number of variables, and constraints, etc.

These precomputed relations are stored in a query database 110 in FIG. 12, and read off when required. The database is indexed by a combination of the expression's operators and operands, which is equivalent to converting the literal expression string into a numeric index, using possibly hashing. Caching strategies are used to quickly retrieve portions of this database, which are frequently used. Since the atomic operations on polytopes are time consuming, pre-computation has the potential of considerably increasing analysis speed. This pre-computation can be done off-line, before the actual analysis is performed.

We note that the relational algebra operators—subset, disjoint, intersection can be used at the conditions in a relational database generalized join. If X and Y are tables containing constraint sets (polytopes), the generalized join X [symbol] Y, is defined as all those tuples (x,y), such that x (a constraint set in X) is a subet of, disjoint from, or intersecting y (a constraint set in Y) respectively. This extends the relational databases to handle the richer relational algebra of polytopes (or general convex bodies if nonlinear convex constraints are allowed).

### Exemplary Application of SCMA

Below we give an example of the utility of the SCMA embodiment of this invention. Consider the task of optimizing a supply chain for unknown future demand. Depending on the future prediction model, the teams involved in the prediction, etc, very different answers can be obtained. For example, for expansion of a retail chain, some future assumptions are possibly:
The total sales of the company will increase by at least Rs 1000 crores to no more than Rs 2000 crores, AND
The product mix will be no more than 5% different from what it is. AND
The industry revenue will experience a minimum of 3% and a maximum of 10% growth.

### OR

The product mix will migrate by at least 10% to higher paying products, AND
The total disposable income available to spend on goods by the customers will not change by more than 10% AND
The industry profit will experience a minimum of 4% and a maximum of 20% growth.
   The first set of assumptions is over variables (Company Sales, Product Mix, Industry Revenue. The second set is over variables (Product Mix, Consumer Disposable Income, Industry Profit). The only variable common is the Product Mix. Clearly optimization under these two sets of assumptions is likely to yield very different answers. Which is correct? The relational algebra engine helps us resolve this dilemma by examining first, if these two sets of assumptions have anything in common (intersecting), or are totally different (disjoint). Then the common set can be separated, and the differences examined for further analysis as outlined in the description.

### REFERENCES

1. [BGN*04] Benisch M., Greenwald A., Naroditskiy V., Tschantz M C., A Stochastic Programming Approach to Scheduling in TAC SCM, Proceedings of the 5^{th} ACM conference on Electronic Commerce, 2004.
2. [SAG*03] Santaso T, Ahmed S, Goetschalckx M, Shapiro A, A Stochastic Programming Approach for Supply Chain Network Design Under Uncertainty, Technical Report, School of Industrial & Systems Engineering, Georgia Institute of Technology, 2003
3. [BT06] Bertsimas Thiele. Robust and Data-Driven Optimization: Modern Decision-Making under Uncertainty. Tutorials in Operations Research, INFORMS, 2006.
4. [BN98] Ben-Tal, A., and Nemirovski, A., A Robust Convex Optimization. Mathematics of Operations Research, 1998.
5. [BN99] Ben-Tal, A., and Nemirovski, A., Robust Solutions to Uncertain Linear Programs, Operations Research Letters, Volume 25, August 1999.
6. [BN00] Ben-Tal, A., and Nemirovski, A., Robust Solutions of Linear Programming Problems contaminated with uncertain data, Mathematical Programming, 2000
7. [MP78] David E. Muller and Franco P. Preparata., Finding Intersection of Two Convex Polyhedra. Theoretical Computer Science, Vol. 7, 1978.
8. [CI01] Jean Pierre Charalambos and Ebroul Izquierdo, Linear Programming Concept Visualization, Proceedings of the Fifth International Conference on Information Visualisation, 2001.
9. [AD00] David Avis and Luc Devroye, Estimating the Number of Vertices of a Polyhedron, Information Processing Letters, February 2000.
10. [LV03] Lovász L., and Vempala S., Simulated Annealing in Convex Bodies and an O*(n⁴) Volume Algorithm, Proceedings of the 44th Annual IEEE Symposium on Foundations of Computer Science, 2003.
11. [ID90] Inselberg A., and Dimsdale B., Parallel Coordinates: A Tool for Visualizing Multi-Dimensional Geometry, IEEE Visualization Conf., 1990, 361-378.
12. [CI95] Chatterjee A., and Inselberg A., Visualizing multi-dimensional polytopes and topologies for tolerances, Doctoral Thesis, ACM, 1995
13. [Sha48] Shannon C. E., A Mathematical Theory of Communication, The Bell System Technical Journal, Vol. 27, 1948.
14. [PA03]. Prasanna G. N. S., and A Vishwanath, Traffic Constraints Instead of Traffic Matrices: Capabilities of a New Approach to Traffic Characterization, ITC, 2003.
15. [CU] Cornell University website for dynamic modeling of supply chain http://www.orie.cornell.edu/orie/research/casestudy/profile.cfm?id=6983.

1. A Computer implemented Decision Support method, comprising the step of feeding information in the form of constraint sets over information elements, and invoking facilities to determine at least one of the following relationships between the said constraint sets:
(a) Determining whether a pair of said constraint sets intersects with each other, i.e. there is a common information element in both said constraint sets;
(b) Determining whether a pair of said constraint sets are disjoint from each other, i.e. there is no common information element in both said constraint sets;
(c) Determining whether a constraint set is a subset of another, i.e., all the information elements satisfying one said constraint set are included in the information elements satisfying the other said constraint set; and
(d) Determining what the distance as measured by an appropriate norm is between a point satisfying one constraint set, and another point satisfying another constraint set.

2. The method of claim 1, where said facility to determine intersection includes determining the intersection volume, and said facility to determine subset includes determining the volume of the subset and superset.

3. The method of claim 1, where the said information elements are values of a set of variables in a supply chain management system.

4. The method of claim 3 where the variables represent one of (a) demand, (b) supply, (c) inventory, (d) cost, (e) revenue or (f) profit or other relevant variables of an entity in a supply chain management system.

5. The method of claim 4, where the said constraints are linear constraints over the said variables.

6. The method of claim 2, where the relationship between said constraints sets is depicted in a diagram depicting said constraints sets with nodes, having
(a) An arrow going from said node corresponding to a constraint set 1 to said node corresponding to a constraint set 2 depicting that constraint set 1 is a subset of constraint set 2;
(b) An bidirectional arrow going between said node corresponding to a constraint set 1 and said node corresponding to a constraint set 2 depicting that constraint set 1 intersects constraint set 2;
(c) A clique of bidirectional arrows between said node corresponding to a constraint set 1, said node corresponding to a constraint set 2, and said node corresponding to a constraint set 3 implying that all three constraint sets intersect; and
(d) A line without arrowheads indicating that a constraint set 1 is equal to a constraint set 2.

7. The method of claim 6, where a labelled line is marked between said node corresponding to said constraint set 1 and said node corresponding to said constraint set 2, said label containing the distance between a point in the said constraint set 1 and another point in said constraint set 2.

8. The method of claim 7, where said distance is the minimum distance between all points in said constraint set 1 and said constraint set 2.

9. The method of claim 7, where said distance is the maximum distance between all points in said constraint set 1 and said constraint set 2.

10. The method of claim 7, where said distance is the distance between the analytic centers between all points in said constraint set 1 and said constraint set 2.

11. The method of claim 6, where a label exists on a constraint set, indicating the volume of the constraint set.

12. The method of claim 2, where a said facility is implemented as a software service, which can be coupled to an existing decision support system.

13. The method of claim 2, where a facility is implemented in a hardware ASIC.

14. The method of claim 4, where a constraint set is obtained from prediction or transformation from a database

15. The method of claim 4, with a facility to provide an answer to a complex query composed of set-theoretic operators.

16. The method of claim 15, with a facility to use common-sub expression eliminination between multiple queries, to reduce computation.

17. The method of claim 16, where pre-computed answers are stored in a query database for subsequent lookup.

18. The method of claim 4, where the value of a said variable is read from the database of a supply chain management system.

19. The method of claim 18, where said facility gives a signal indicating satisfaction or non-satisfaction of a said constraint set, or satisfaction or non-satisfaction of a complex query on these same constraint sets, by said variable value or values.

20. The method of claim 19, where said variable value or values are updated in real time by input to said supply chain management system.

21. The method of claim 20, where the value of a said variable or variables is/are read from the database of said supply chain management system using an XML file.

22. A Decision support system comprising input means to receive information in the form of sets of constraints over information elements, and invoking facilities to determine at least one of the following relationships between the said constraint sets:
(a) Determining whether a pair of said constraint sets intersects with each other;
(b) Determining whether a pair of said constraint sets are disjoint from each other;
(c) Determining whether a constraint set is a subset of another; or
(d) Determining what the distance is as measured by an appropriate norm is between a point satisfying one constraint set, and another point satisfying another constraint set.

23. The system of claim 22, entirely operating on a mobile phone
